(19) United States
(12) Patent Application Publication
(10) Pub. No.: US 2018/0114217 A1
(43) Pub. Date: Apr. 26, 2018

(54) WALLET-BASED ALERTS IN A SHARED SERVICE MODEL ENVIRONMENT

(71) Applicant: MasterCard International Incorporated, Purchase, NY (US)

(72) Inventor: Manoneet Kohli, O'Fallon, MO (US)

(21) Appl. No.: 15/298,643

(22) Filed: Oct. 20, 2016

(51) Int. Cl. G06Q 20/36; G06K 19/06; G06K 7/14; G06Q 20/32

(52) U.S. Cl. CPC G06Q 20/3674; G06Q 20/322; G06K 7/1417; G06K 19/06037

(57) ABSTRACT

A method includes utilizing a digital wallet on a mobile device to transact for provision of a shared service from a service provider wherein the digital wallet is provided by a wallet provider and receiving at the mobile device via a communication between the digital wallet and the wallet provider an alert comprised of information indicative of a status of the provision of the shared service, wherein the alert activates the digital wallet to inform an operator of the mobile device of this pending alert when the mobile device is activated

### FIELD

The present application generally relates to wallet based applications. In particular, the present application relates to an apparatus and methods for enabling wallet based consumption activities in a shared service environment.

### BACKGROUND

A shared services model is a generally commercial model present in a variety of environments. In accordance with such a model, a merchant may offer access to a shared service or piece of equipment to a consumer. Typically, the environments in which such models are employed involve unattended equipment. For example, a laundry service may allow consumers to utilize washing and drying machines located in a commonly accessible location in exchange for payment.

In this example, it is common for consumers to leave the premises for the duration of a wash or dry cycle. In such instances, when a consumer fails to return so as to be present at the end of a cycle, equipment may sit idle. This situation results in longer wait times for consumers wishing to use the idle equipment as well as a loss in revenue for the merchant. Unfortunately, because the merchant often times has no information as to the identity and location of patrons/consumers, there is no way for the merchant to communicate with consumers to address such inefficiencies. Even if a merchant was able to communicate with consumers of the services, the merchant has no way of enforcing time allocation as part of a shared service agreement. Additionally, while privacy of a consumer may be provided in a service model in which the merchant has no information as to the identity of the consumer, ensuring privacy while also enriching the merchant's ability to address such inefficiencies through contacting consumers is a challenge at best.

What is needed is a system and method for using same to provide event notification to consumers of shared services that enriches a merchant's ability to address inefficiencies related to use of shared services, optionally including enforcing time allocation service agreement terms, while maintaining confidentiality of such consumers.

### SUMMARY

In accordance with an exemplary and non-limiting embodiment, a method comprises utilizing a digital wallet on a mobile device to transact for provision of a shared service from a service provider wherein the digital wallet is provided by a wallet provider and receiving at the mobile device via a communication between the digital wallet and the wallet provider an alert comprised of information indicative of a status of the provision of the shared service.

In accordance with an exemplary and non-limiting embodiment, a method comprises transacting with a digital wallet on a mobile device to provide a shared service wherein the digital wallet is provided by a wallet provider and communicating to the wallet provider an alert comprised of information indicative of a status of the provision of the shared service.

In accordance with an exemplary and non-limiting embodiment, a method comprises transacting with a digital wallet on a mobile device to provide a shared service wherein the digital wallet is provided by a wallet provider, enabling provision of the shared service and communicating to the mobile device via a wallet provider an alert comprised of information indicative of a status of the provision of the shared service.

In accordance with an exemplary and non-limiting embodiment, a method comprises receiving at a shared service provider a shared service provision request from a mobile device, the request including information that facilitates identifying a digital wallet disposed on the mobile device and a shared service device identifier, wherein the information that facilitates identifying the digital wallet is encrypted so that the shared service provider cannot determine the identity of the digital wallet, the request including data indicative of a provider of the digital wallet, processing the request to determine a contact channel for transacting for the provision of the shared service with the digital wallet via the provider of the digital wallet, transacting with the digital wallet by communicating the information in the shared service provision request via the determined digital wallet provider contact channel and receiving an authorization to provision the requested shared service, determining at least one of an alert time relative to receiving the authorization and an alert time relative to an indication from the shared service device that the provisioned shared service has commenced and alerting the mobile device at the determined alert time by sending an alert message to the wallet provider, wherein the alert message facilitates the wallet provider accessing a notification feature of the disposed digital wallet through which a portion of the alert message is provided to a user of the mobile device.

### BRIEF DESCRIPTION OF THE DRAWINGS

In the drawings, which are not necessarily drawn to scale, like numerals may describe substantially similar components throughout the several views. Like numerals having different letter suffixes may represent different instances of substantially similar components. The drawings illustrate generally, by way of example, but not by way of limitation, a detailed description of certain embodiments discussed in the present document.

FIG. 1 illustrates a schematic diagram of a deployment of the methods and systems of shared service alert through a wallet provider to a wallet-equipped mobile device;

FIG. 2 illustrates a flow chart of purchasing, commencing, and monitoring a status of a provisioned shared service for generating an alert; and

FIG. 3 illustrates a flow chart for an embodiment of the methods and systems of shared service provision and wallet-based alert described herein.

### DETAILED DESCRIPTION

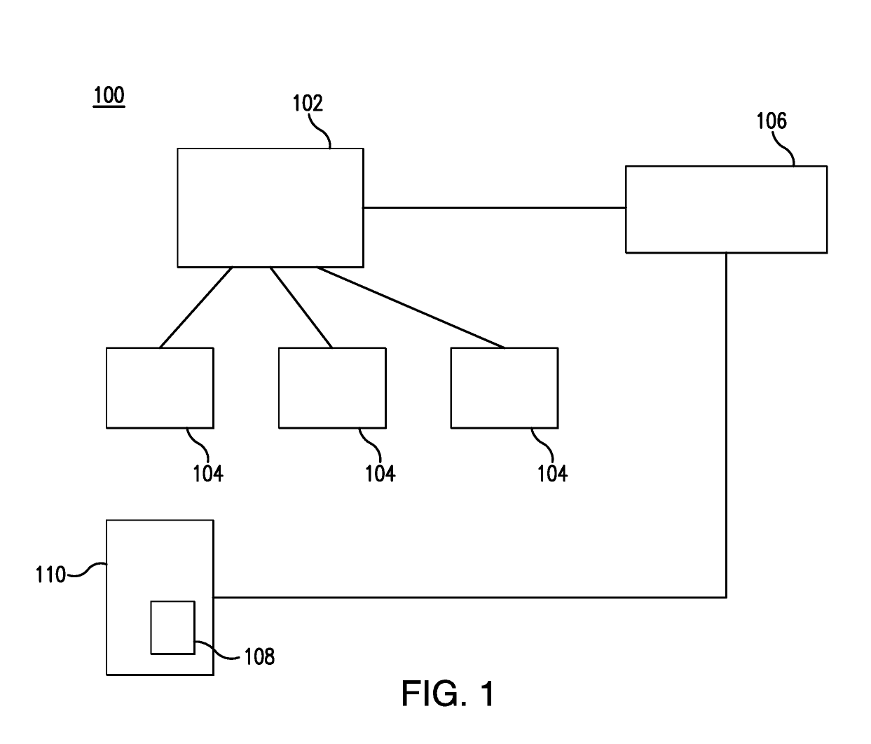

With reference to FIG. 1, there is illustrated an exemplary and non-limiting embodiment of a wallet-based event notification system 100 for shared services environments. As illustrated, a merchant 102 is in electronic contact with one or more devices 104. The devices 104 may be configured to allow for consumer access on a shared basis, such as a time allocated basis per service usage. Communication between the devices 104 and the merchant 102 may be wired or wireless and may, for example, involve Wi-Fi or Internet communication.

There is further illustrated at least one wallet provider 106 in communication with each merchant 102. Wallet provider 106 may configure a digital wallet 108 for use on a consumer's mobile device 110. As used herein, a “digital wallet” refers to an application executing on an electronic device that allows an individual to make electronic commerce transactions including, for example, purchasing items on-line with a computer or using a smartphone to purchase something at a store wherein an individual's bank account or credit or debit card, for example may be linked to the digital wallet.

As a result of configuring and supplying a digital wallet 108 to a consumer for execution on a mobile device 110, the wallet provider 106 may have access to personal information describing the consumer including, but not limited to, contact information, financial information, security information, location information and the like. As a result, the wallet provider 106 may communicate with consumers via a network using identification information known to the wallet provider 106. For example, the wallet provider may text or email a consumer on his mobile device 110 upon which the digital wallet 108 has been installed.

As described, a merchant 102 may receive payment for use of a device 104 by a consumer via a digital wallet 108. As a result of such a payment transaction, the merchant may receive limited information identifying the transaction. For example, a merchant may receive a unique transaction identifier, or “id”, that uniquely defines the transaction. In exemplary embodiments, this transaction id is insufficient to enable the merchant 102 to independently contact the consumer via a mobile device 110. However, as described above, the wallet provider 106 has access to information, both static and dynamic, related to the digital wallet 108 operated by the consumer. As described more fully below, a merchant 102 may, as the result of information sensed or derived from the devices 104, communicate with the wallet provider 106 to indirectly exchange information such as, for example, an alert, with a mobile device 110 or, conversely, to query information related to a state of the mobile device 110.

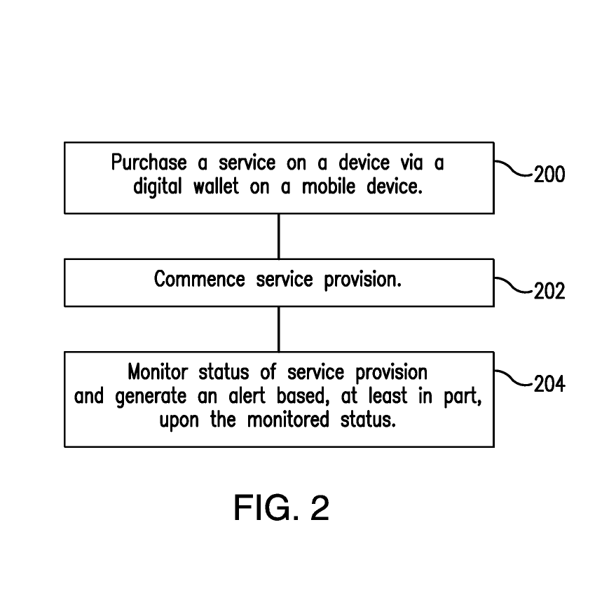

In accordance with an exemplary and non-limiting embodiment, the system 100 may be employed to provide an alert to a consumer when a consumed service is completed or nearing completion. With reference to FIG. 2, there is illustrated a method for providing such an alert in accordance with an exemplary and non-limiting embodiment. First, at step 200, a consumer operating a mobile device on which a digital wallet has been installed purchases time on a device 104. For example, a consumer may enter a laundry facility and may proceed to purchase a single wash cycle on a designated washing machine using the digital wallet 108 installed and operating on the mobile device of the consumer. In some embodiments, the mere act of purchasing time on a particular device may provide the merchant 102 with information indicative of the particular machine or service associated with the purchase. For example, a consumer may wirelessly utilize a digital wallet 108 on a mobile device 110 to complete a transaction at the site of a specific device 104 and, for example, start a wash cycle. In yet another embodiment, a consumer may scan an identifier unique to a particular device such as, for example, a QR code, and may use the scanned identifier to complete a transaction using the digital wallet 108. In yet another embodiment, a sensor on the device 104, such as a bluetooth communication channel, near-field communication sensor, optical port, imaging device and the like, may sense the presence of a mobile device 110 and may interact with the digital wallet 108 executing thereupon to complete a transaction.

In yet another embodiment, the digital wallet 108 may communicate with at least one of the merchant 102 and a device 104 to determine transaction information about the prospective purchase including, but not limited to, device identifier, a price of the service, a merchant identifier, etc. Once received, the digital wallet 108 may send this information to the wallet provider 106. The wallet provider 106 may then approve the transaction and issue a secure token, which is then transmitted to the digital wallet 108. Upon receipt by the digital wallet 108, the token may be transmitted from the digital wallet to the merchant 102 to complete the payment process. The merchant 102 may provide the token to the wallet provider 106 at a later time to receive payment. Alternatively, the token may be transmitted to the merchant 102 directly from the wallet provider 106. A confirmation of such transmission may be received by the wallet 108 from the wallet provider 106, from the merchant (e.g., through a WiFi, cellular or similar network connection), or from the device 104.

Regardless of the method by which the transaction takes place, communication between consumer and the merchant 102 is limited such that information describing the consumer is restricted to select information that may ensure confidentiality of the consumer, such as non-personal information. For example, the merchant 102 may not be provided with information sufficient to allow the merchant 102 to independently send a message to the consumer or to directly query the consumer. However, as described more fully below, the merchant 102 may send alerts to a mobile device 110 by communicating with the wallet provider 106. This capability may be enabled by an association established via the digital wallet 108 and the wallet provider 106 with the merchant 102 and/or the device 104 through, for example, purchase of a shared service as described herein.

Once the purchase of a service is complete, the service commences, at step 202, to be provided. At step 204, the status of the service provision is monitored by the merchant and an alert is generated based, at least in part, upon the monitored status. As noted above, the provision of numerous services may be for a predetermined period of time known to both the consumer and the merchant 102. For example, when a consumer using a digital wallet 108 purchases a wash cycle on a washing machine device 104, it may be determined that the cycle will end in approximately forty-five minutes. As a result, both the merchant 102 and the consumer are informed at the commencement of the cycle that action to vacate the rented washing device 104 may need to be taken forty-five minutes in the future.

In yet other embodiments, the time required to complete a purchased service may be dynamically determined and updated. For example, several minutes may pass between the purchase of a service and the commencement of the service. In the present example, it may take several minutes to load a washing machine device 104 before commencing a forty-five minute wash cycle. In such instances, the merchant 102, perhaps with input from a sensor on the device 104, may not begin timing the forty-five minute period until the cycle commences. In yet other embodiments, the service itself may be for a time period that is not easily determinable until provision of the service is underway. For example, a typical dry cycle may take no more than 90 minutes but it may require less time. In such instances, a sensor in a drying device 104 may sense the humidity in the device 104 and may periodically communicate information to the merchant from which may be determined an estimated time until completion of the service.

Whether based, at least in part, on a static or dynamic time estimation, the merchant may generate alerts for delivery to a mobile device 110 to inform the associated consumer that the service is nearly completed. As described above, the merchant 102 does not possess information sufficient to allow the merchant to communicate directly with the mobile device 110. In one embodiment, the merchant 102 may communicate with the wallet provider 106 using information gleaned from the transaction such as, for example, a transaction id. In other embodiments, the merchant may communicate with the wallet provider 106 using information derived from a token communicated to the merchant 102 as described above.

Regardless of the method by which the merchant 102 identifies the current consumer-device service transaction to the wallet provider 106, the wallet provider 106 may proceed to communicate with the consumer's mobile device 110. Such communication may be via the associated installed digital wallet 108, via email, via text message, or other communication methods. In some embodiments, the merchant 102 may send a request for the wallet provider 106 to inform the consumer via an alert that the service for which the consumer transacted is nearing completion. In such a scenario, the wallet provider 106 receives the request from the merchant 102 and uses information contained in the request, such as a transaction id or a unique token identifier attribute, to determine the identity of the digital wallet 108 operating on a mobile device 110 via which the transaction was completed.

Once identified, the wallet provider 106 may communicate with the consumer via the mobile device and/or the digital wallet 108 in accordance with the nature of communication received by the wallet provider 106 from the merchant 102. In the event that the merchant 102 has requested that an alert be sent to the consumer, the wallet provider 106 may message the consumer such as by sending a text message or an email to mobile device 110 upon which the digital wallet 108 having an identified wallet id is resident. In some embodiments, the communication from the wallet provider 106 to the mobile device 110 may occur when the mobile device 110 is in an unpowered state. In such an instance, the digital wallet 108 may operate to inform the consumer operator of the mobile device 110 of all pending alerts upon powering up the mobile device 110. Likewise the alert may activate the digital wallet to inform the consumer operator of this pending alert when the mobile device is activated, such as from a sleep mode. This may occur when there is a temporal delay after the time of the alert of a long enough duration that the mobile device enters a sleep mode, and the client device is activated out of sleep mode upon informing the consumer operator.

In other embodiments, a merchant 102 may query the wallet provider 106 for additional information. Such information may be used in the formulation of an alert or, in some instances, to determine that an alert is not necessary. For example, it may have been predetermined to send a consumer an alert five minutes prior to the completion of a service for which the consumer transacted. Prior to sending a request to the wallet provider 106 to send an alert to the appropriate digital wallet 108, the merchant 102 may query the wallet provider 106 to return location information for the mobile device 110 on which the digital wallet 108 is resident. The wallet provider 106 may proceed to query the mobile device 110, such as via communication with the digital wallet 108 disposed thereupon, to receive location information, such as in the form of latitude and longitude coordinates. The wallet provider 106 may then respond to the merchant 102 with the received location information. In some embodiments, the merchant may include location information for the device 104 at issue and the wallet provider 106 may determine and reply with a delta location indicative of a linear difference in distance between the two locations. In this way, the mobile device's absolute location is not revealed to the merchant 102.

Regardless of the format of the location information received by the merchant 102, such information may be utilized to determine if an alert is to be sent to a transacting consumer. For example, if the merchant 102 determines that the transacted service will terminate in 10 minutes and the mobile device 110 comprising the digital wallet 108 with which the transaction was completed is twenty feet from the device 104, the merchant may decide to not send an alert as it is probable that the consumer is prepared to complete his use of the device 104 at the time of service termination. Conversely, if the merchant 102 determines that the transacted service will terminate in 10 minutes and the mobile device 110 comprising the digital wallet 108 with which the transaction was completed is fifteen miles from the device 104, the merchant may choose to send an alert.

In accordance with an exemplary and non-limiting embodiment, alerts may include information indicative of tiered pricing. For example, a merchant 102 may send an alert to a consumer via a digital wallet 108 informing the consumer that the predetermined usage of the transacted device 104 is coming to an end and every additional ten minutes that transpires prior to the consumer relinquishing use of the device 104 will result in an additional charge. In some instances, the penalty may be based, at least in part, upon an attribute of the consumer. For example, if the merchant recognizes that a wallet identifier for a transaction is a frequent customer, the additional charge may be reduced. Further instances of a user exceeding his time allocation for a service may result in charges for each unit of extended time increasing; thereby charging more for extended time to a repeat offender than a casual or first time offender.

Further, because the merchant has access to the status of all devices 104 in an establishment, the merchant may assess a larger penalty when all devices are in use than when there is sufficient excess capacity to meet the needs of other consumers. In one embodiment, a consumer may respond to an alert by sending a message from the digital wallet 110 to the wallet provider 106 for delivery to the merchant 102. Such a message may consist of a preapproval to charge the digital wallet 108 for an additional fee to preemptively extend the time of device usage.

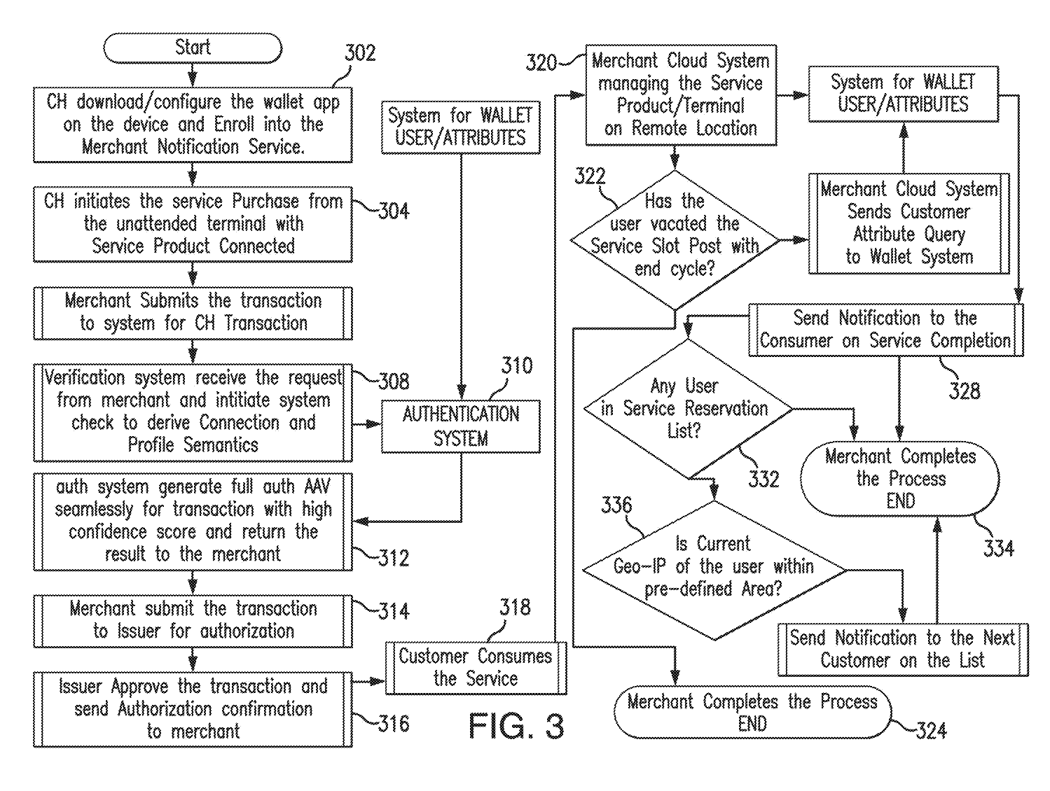

With reference to FIG. 3, there is illustrated a method according to an exemplary and non-limiting embodiment. At step 302, a consumer downloads and configures a digital wallet application 108 onto a mobile device 110 and enrolls in a merchant notification service. At step 304, the consumer initiates a service purchase from an unattended device 104 with connection to a merchant 102. Then, at step 306, the merchant 102 submits the transaction to the wallet provider 106. At step 308, the wallet provider verification system receives the request from the merchant and initiates a system check to derive connection and profile semantics [Please provide further detail]. At step 310, the derived connection and profile semantics are received at a wallet provider authentication system as well as input from the wallet provider system for wallet user/attributes [Please provide further detail].

Next, at step 312, the wallet provider authentication system generates a full authorization AAV [Please define] in a seamless or near seamless fashion for the transaction with a high confidence score and returns the result to the merchant 102. Then, at step 314, the merchant 102 submits the transaction to an issuer for authorization [Are the issuer and wallet provider not the same?]. Next, at step 316, the issuer approves the transaction and sends authorization confirmation to the merchant. Then, at step 318, the customer commences to consume the service. At step 320, the merchant may monitor the service product from a remote location. If, at step 322, it is determined that the consumer has vacated the service slot post at the end of the cycle, the process proceeds to step 324 whereat the merchant completes the process.

Conversely, if, at step 322, the consumer has not vacated the service slot post at the end of the cycle, the merchant may send a customer attribute query to the wallet provider. At step 328, the wallet provider system accesses the attributes of the customer and sends a notification to the customer upon service completion. Next, at step 332, if it is determined that there are no additional users in a service reservation list, processing continues to step 334 whereat the merchant completes the process. Conversely, if, at step 332, it is determined that there are additional users in a service reservation list, then, at step 336, a determination is made if the customer is within a predefined area and, if he is, a notification is sent to the next customer on the reservation list.

In accordance with an exemplary and non-limiting embodiment, a shared service provider of a shared service, such as a merchant 102, may receive a provision request from a mobile device 110 wherein the request includes information that facilitates identifying a digital wallet 108 disposed on the mobile device 110 and a shared service device identifier.

In some instances, the information that facilitates identifying the digital wallet to the merchant may be encrypted so that the merchant 102 cannot determine the identity of the digital wallet 108. The request may further include data indicative of a provider of the digital wallet such as a wallet provider identifier. The request may then be processed to determine a contact channel for transacting for the provision of the shared service with the digital wallet via the provider of the digital wallet. In some instances, this contact channel may be either a wired or wireless mode of communication; the contact channel may be enabled, at least in part, by the wallet provider identifier.

Next, the merchant 102 may transact with the digital wallet 108 by communicating the information in the shared service provision request via the determined digital wallet provider contact channel and receiving an authorization to provision the requested shared service. The merchant may then determine at least one of an alert time relative to receiving the authorization and an alert time relative to an indication from the shared service device that the provisioned shared service has commenced and may then alert the mobile device 110 at the determined alert time by sending an alert message to the wallet provider, wherein the alert message facilitates the wallet provider 106 accessing a notification feature of the disposed digital wallet 108 through which a portion of the alert message is provided to a user of the mobile device 110.

The programmed methods and/or instructions described herein may be deployed in part or in whole through a machine that executes computer software, program codes, and/or instructions on a processor or processors. “Processor” used herein is synonymous with the plural “processors” and the two terms may be used interchangeably unless context clearly indicates otherwise. The processor may be part of a server, client, network infrastructure, mobile computing platform, stationary computing platform, or other computing platform. A processor may be any kind of computational or processing device capable of executing program instructions, codes, binary instructions and the like. The processor may be or include a signal processor, digital processor, embedded processor, microprocessor or any variant such as a co-processor (math co-processor, graphic co-processor, communication co-processor and the like) and the like that may directly or indirectly facilitate execution of program code or program instructions stored thereon. In addition, the processor may enable execution of multiple programs, threads, and codes. The threads may be executed simultaneously to enhance the performance of the processor and to facilitate simultaneous operations of the application. By way of implementation, methods, program codes, program instructions and the like described herein may be implemented in one or more thread. The thread may spawn other threads that may have assigned priorities associated with them; the processor may execute these threads based on priority or any other order based on instructions provided in the program code. The processor may include memory that stores methods, codes, instructions and programs as described herein and elsewhere. The processor may access a storage medium through an interface that may store methods, codes, and instructions as described herein and elsewhere. The storage medium associated with the processor for storing methods, programs, codes, program instructions or other type of instructions capable of being executed by the computing or processing device may include but may not be limited to one or more of a CD-ROM, DVD, memory, hard disk, flash drive, RAM, ROM, cache and the like.

A processor may include one or more cores that may enhance speed and performance of a multiprocessor. In embodiments, the process may be a dual core processor, quad core processors, other chip-level multiprocessor and the like that combine two or more independent cores (called a die).

The methods and systems described herein may be deployed in part or in whole through a machine that executes computer software on a server, client, firewall, gateway, hub, router, or other such computer and/or networking hardware. The software program may be associated with a server that may include a file server, print server, domain server, Internet server, intranet server and other variants such as secondary server, host server, distributed server and the like. The server may include one or more of memories, processors, computer readable media, storage media, ports (physical and virtual), communication devices, and interfaces capable of accessing other servers, clients, machines, and devices through a wired or a wireless medium, and the like. The methods, programs or codes as described herein and elsewhere may be executed by the server. In addition, other devices required for execution of methods as described in this application may be considered as a part of the infrastructure associated with the server.

The server may provide an interface to other devices including, without limitation, clients, other servers, printers, database servers, print servers, file servers, communication servers, distributed servers and the like. Additionally, this coupling and/or connection may facilitate remote execution of program across the network. The networking of some or all of these devices may facilitate parallel processing of a program or method at one or more location without deviating from the scope. In addition, any of the devices attached to the server through an interface may include at least one storage medium capable of storing methods, programs, code and/or instructions. A central repository may provide program instructions to be executed on different devices. In this implementation, the remote repository may act as a storage medium for program code, instructions, and programs.

The software program may be associated with a client that may include a file client, print client, domain client, Internet client, intranet client and other variants such as secondary client, host client, distributed client and the like. The client may include one or more of memories, processors, computer readable media, storage media, ports (physical and virtual), communication devices, and interfaces capable of accessing other clients, servers, machines, and devices through a wired or a wireless medium, and the like. The methods, programs or codes as described herein and elsewhere may be executed by the client. In addition, other devices required for execution of methods as described in this application may be considered as a part of the infrastructure associated with the client.

The client may provide an interface to other devices including, without limitation, servers, other clients, printers, database servers, print servers, file servers, communication servers, distributed servers and the like. Additionally, this coupling and/or connection may facilitate remote execution of program across the network. The networking of some or all of these devices may facilitate parallel processing of a program or method at one or more location without deviating from the scope. In addition, any of the devices attached to the client through an interface may include at least one storage medium capable of storing methods, programs, applications, code and/or instructions. A central repository may provide program instructions to be executed on different devices. In this implementation, the remote repository may act as a storage medium for program code, instructions, and programs.

The methods and systems described herein may be deployed in part or in whole through network infrastructures. The network infrastructure may include elements such as computing devices, servers, routers, hubs, firewalls, clients, personal computers, communication devices, routing devices and other active and passive devices, modules and/or components as known in the art. The computing and/or non-computing device(s) associated with the network infrastructure may include, apart from other components, a storage medium such as flash memory, buffer, stack, RAM, ROM and the like. The processes, methods, program codes, instructions described herein and elsewhere may be executed by one or more of the network infrastructural elements.

The methods, program codes, and instructions described herein and elsewhere may be implemented on a cellular network having multiple cells. The cellular network may either be frequency division multiple access (FDMA) network or code division multiple access (CDMA) network. The cellular network may include mobile devices, cell sites, base stations, repeaters, antennas, towers, and the like. The cell network may be a GSM, GPRS, 3G, EVDO, mesh, or other networks types.

The methods, programs codes, and instructions described herein and elsewhere may be implemented on or through mobile devices. The mobile devices may include navigation devices, cell phones, mobile phones, mobile personal digital assistants, laptops, palmtops, netbooks, pagers, electronic books readers, music players and the like. These devices may include, apart from other components, a storage medium such as a flash memory, buffer, RAM, ROM and one or more computing devices. The computing devices associated with mobile devices may be enabled to execute program codes, methods, and instructions stored thereon. Alternatively, the mobile devices may be configured to execute instructions in collaboration with other devices. The mobile devices may communicate with base stations interfaced with servers and configured to execute program codes. The mobile devices may communicate on a peer to peer network, mesh network, or other communications network. The program code may be stored on the storage medium associated with the server and executed by a computing device embedded within the server. The base station may include a computing device and a storage medium. The storage device may store program codes and instructions executed by the computing devices associated with the base station.

The computer software, program codes, and/or instructions may be stored and/or accessed on machine readable media that may include: computer components, devices, and recording media that retain digital data used for computing for some interval of time; semiconductor storage known as random access memory (RAM); mass storage typically for more permanent storage, such as optical discs, forms of magnetic storage like hard disks, tapes, drums, cards and other types; processor registers, cache memory, volatile memory, non-volatile memory; optical storage such as CD, DVD; removable media such as flash memory (e.g. USB sticks or keys), floppy disks, magnetic tape, paper tape, punch cards, standalone RAM disks, Zip drives, removable mass storage, off-line, and the like; other computer memory such as dynamic memory, static memory, read/write storage, mutable storage, read only, random access, sequential access, location addressable, file addressable, content addressable, network attached storage, storage area network, bar codes, magnetic ink, and the like.

The methods and systems described herein may transform physical and/or or intangible items from one state to another. The methods and systems described herein may also transform data representing physical and/or intangible items from one state to another.

The elements described and depicted herein, including in flow charts and block diagrams throughout the figures, imply logical boundaries between the elements. However, according to software or hardware engineering practices, the depicted elements and the functions thereof may be implemented on machines through computer executable media having a processor capable of executing program instructions stored thereon as a monolithic software structure, as standalone software modules, or as modules that employ external routines, code, services, and so forth, or any combination of these, and all such implementations may be within the scope of the present disclosure. Examples of such machines may include, but may not be limited to, personal digital assistants, laptops, personal computers, mobile phones, other handheld computing devices, medical equipment, wired or wireless communication devices, transducers, chips, calculators, satellites, tablet PCs, electronic books, gadgets, electronic devices, devices having artificial intelligence, computing devices, networking equipment, servers, routers and the like. Furthermore, the elements depicted in the flow chart and block diagrams or any other logical component may be implemented on a machine capable of executing program instructions. Thus, while the foregoing drawings and descriptions set forth functional aspects of the disclosed systems, no particular arrangement of software for implementing these functional aspects should be inferred from these descriptions unless explicitly stated or otherwise clear from the context. Similarly, it may be appreciated that the various steps identified and described above may be varied, and that the order of steps may be adapted to particular applications of the techniques disclosed herein. All such variations and modifications are intended to fall within the scope of this disclosure. As such, the depiction and/or description of an order for various steps should not be understood to require a particular order of execution for those steps, unless required by a particular application, or explicitly stated or otherwise clear from the context.

The methods and/or processes described above, and steps thereof, may be realized in hardware, software or any combination of hardware and software suitable for a particular application. The hardware may include a general purpose computer and/or dedicated computing device or specific computing device or particular aspect or component of a specific computing device. The processes may be realized in one or more microprocessors, microcontrollers, embedded microcontrollers, programmable digital signal processors or other programmable device, along with internal and/or external memory. The processes may also, or instead, be embodied in an application specific integrated circuit, a programmable gate array, programmable array logic, or any other device or combination of devices that may be configured to process electronic signals. It may further be appreciated that one or more of the processes may be realized as a computer executable code capable of being executed on a machine readable medium.

The computer executable code may be created using a structured programming language such as C, an object oriented programming language such as C++, or any other high-level or low-level programming language (including assembly languages, hardware description languages, and database programming languages and technologies) that may be stored, compiled or interpreted to run on one of the above devices, as well as heterogeneous combinations of processors, processor architectures, or combinations of different hardware and software, or any other machine capable of executing program instructions.

Thus, in one aspect, each method described above and combinations thereof may be embodied in computer executable code that, when executing on one or more computing devices, performs the steps thereof. In another aspect, the methods may be embodied in systems that perform the steps thereof, and may be distributed across devices in a number of ways, or all of the functionality may be integrated into a dedicated, standalone device or other hardware. In another aspect, the means for performing the steps associated with the processes described above may include any of the hardware and/or software described above. All such permutations and combinations are intended to fall within the scope of the present disclosure.

While the methods and systems described herein have been disclosed in connection with certain preferred embodiments shown and described in detail, various modifications and improvements thereon may become readily apparent to those skilled in the art. Accordingly, the spirit and scope of the methods and systems described herein is not to be limited by the foregoing examples, but is to be understood in the broadest sense allowable by law.

We claim:

1. A method comprising:
utilizing a digital wallet on a mobile device to transact for provision of a shared service from a service provider wherein the digital wallet is provided by a wallet provider; and
receiving at the mobile device via a communication between the digital wallet and the wallet provider an alert comprised of information indicative of a status of the provision of the shared service, wherein the alert activates the digital wallet to inform an operator of the mobile device of this pending alert when the mobile device is activated.

2. The method of claim 1 wherein the status is indicative of an impending completion of the shared service.

3. The method of claim 1 wherein the alert is indicative of a tiered pricing event.

4. The method of claim 1 further comprising, in response to receiving the alert, transacting for the provision of an additional shared service.

5. The method of claim 4 wherein the provision of the additional shared service is performed in accordance with a tiered pricing system.

6. The method of claim 1, wherein at least one communication of an alert occurs when the mobile device is powered off.

7. A method comprising:
transacting with a digital wallet on a mobile device to provide a shared service wherein the digital wallet is provided by a wallet provider; and
communicating to the wallet provider an alert comprised of information indicative of a status of the provision of the shared service.

8. The method of claim 7 wherein the status is indicative if an impending completion of the shared service.

9. The method of claim 7 wherein the alert is indicative of a tiered pricing event.

10. The method of claim 7 further comprising, in response to communicating the alert, transacting for the provision of an additional shared service.

11. The method of claim 10 wherein the provision of the additional shared service is performed in accordance with a tiered pricing system.

12. A method comprising:
transacting with a digital wallet on a mobile device to provide a shared service wherein the digital wallet is provided by a wallet provider;
enabling provision of the shared service; and
communicating to the mobile device via a wallet provider an alert comprised of information indicative of a status of the provision of the shared service, wherein the alert activates the digital wallet to inform an operator of the mobile device of this pending alert when the mobile device is activated.

13. The method of claim 12 wherein communicating with the wallet provider comprises transmitting a transaction identifier.

14. The method of claim 12, further comprising querying a location of the mobile device via a communication with the wallet provider.

15. The method of claim 12, further comprising receiving the location of the mobile device from the wallet provider.

16. The method of claim 15, wherein the alert is determined based, at least in part, upon the received location.

17. The method of claim 12, wherein transacting with the digital wallet comprises receiving at least one of a digital wallet identifier and a mobile device identifier.

18. A method comprising:
receiving at a shared service provider a shared service provision request from a mobile device, the request including information that facilitates identifying a digital wallet disposed on the mobile device and a shared service device identifier, wherein the information that facilitates identifying the digital wallet is encrypted so that the shared service provider cannot determine the identity of the digital wallet, the request including data indicative of a provider of the digital wallet;
processing the request to determine a contact channel for transacting for the provision of the shared service with the digital wallet via the provider of the digital wallet;
transacting with the digital wallet by communicating the information in the shared service provision request via the determined digital wallet provider contact channel and receiving an authorization to provision the requested shared service;
determining at least one of an alert time relative to receiving the authorization and an alert time relative to an indication from the shared service device that the provisioned shared service has commenced; and
alerting the mobile device at the determined alert time by sending an alert message to the wallet provider, wherein the alert message facilitates the wallet provider accessing a notification feature of the disposed digital wallet.
